(19) United States
(12) Patent Application Publication
(10) Pub. No.: US 2026/0014790 A1
(43) Pub. Date: Jan. 15, 2026

(54) SEGMENTED FILM

(71) Applicant: Shenzhen Lifengda Technology Co., Ltd, Shenzhen (CN)

(72) Inventors: Hongxuan DENG, Shenzhen (CN); Xin TENG, Shenzhen (CN)

(21) Appl. No.: 18/810,068

(22) Filed: Aug. 20, 2024

(30) Foreign Application Priority Data
Jul. 12, 2024 (CN) 2024216615950

(51) Int. Cl. B32B 37/26; B32B 3/16; B32B 3/30; B32B 7/12

(52) U.S. Cl. CPC B32B 37/26; B32B 3/16; B32B 3/30; B32B 7/12; B32B 2037/268

(57) ABSTRACT

The utility model discloses a segmented film, including a surface protective film and a bottom film which are sequentially arranged from top to bottom, where the surface protective film includes substrate for the surface protective films and adhesive layers, the bottom film includes release layers and a dust-sticking adhesive layer, and the bottom film is divided into several parts. According to the layered and segmented structure of the bottom film of the utility model, the film sticking method can be completed easily by untrained personnel; furthermore, the technical effect of avoiding the adsorption of dust and cilia in the air and removing residual dust on a screen by sticking can be achieved, dust and bubbles are avoided, and the yield is very high.

### CROSS-REFERENCE TO RELATED APPLICATIONS

The present application claims priority to Chinese Patent Application No. 2024216615950, filed July 12, 2024, the entire disclosure of which is incorporated herein by reference.

### TECHNICAL FIELD

The utility model relates to the technical field of a display assistance device, and in particular to a segmented film.

### BACKGROUND

At present, mobile phones, tablets and other electronic devices are very popular, the screen display effect is getting better and better, and screen protective films are also varied. The screen protective films not only can protect screens physically, but also can protect eyes and prevent ultraviolet rays. The structures of the screen protective films on the current market are relatively simple, so that the film sticking method is also a traditional method of covering the whole screen and tearing the film at one time, resulting in low film-sticking yield, difficulty for non-professional personnel to operate, and poor effect after film sticking. In particular, the mainstream screen protective films on the current market are all to cover an actual use film with one layer of release film. During use, the actual use film is stuck on the screen directly after a surface film is torn at one time, so it is difficult for hard films to align frames, and bubbles and dust are prone to occur in the middle, resulting in high film-sticking difficulty.

### SUMMARY

An objective of the utility model is to provide a segmented film, so as to solve the problems in the background art.

To achieve the foregoing objective, the utility model provides the following technical solution:

a segmented film includes a surface protective film and a bottom film which are sequentially arranged from top to bottom, where the surface protective film includes substrate for the surface protective films and adhesive layers, the bottom film includes release layers and a dust-sticking adhesive layer, and the bottom film is divided into several parts.

In a further embodiment, the surface protective film has a double-layer structure, including an upper removing layer and a lower actual use layer; and each layer includes the substrate for the surface protective film and the adhesive layer which are combined together.

In a further embodiment, the actual use layer is a layer of film body formed by performing anti-reflection (AR) treatment, anti-glare (AG) treatment, anti-blue-light treatment, anti-peep treatment, anti-fingerprint treatment and anti-scratch treatment or self-repairing treatment on a surface of a PET film, a PC film, a PMMA film or a TAC film.

In a further embodiment, the bottom film includes a release layer, a substrate layer, the dust-sticking adhesive layer and the release layer which are sequentially overlapped together from top to bottom.

In a further embodiment, the release layer, the substrate layer and the dust-sticking adhesive layer on the bottom film from top to bottom are of a split structure, and the release layer at the bottom layer is of an integral structure.

In a further embodiment, the substrate layer is a PET film, a PC film, a PMMA film or a TAC film.

In a further embodiment, the bottom film is divided into left and right sections in a midline.

In a further embodiment, alignment handles as protruding portions are respectively arranged at two ends of the film.

In a further embodiment, the alignment handles are located on a removing layer of the surface protective film or on the bottom film, and the alignment handles are arranged diagonally.

Compared with the prior art, the utility model has the following beneficial effects: according to the layered and segmented structure of the bottom film of the utility model, the film sticking method can be completed easily by untrained personnel; furthermore, the technical effect of avoiding the adsorption of dust and cilia in the air can be achieved, dust and bubbles are avoided, and the yield is very high.

### BRIEF DESCRIPTION OF DRAWINGS

FIG. 1 is a schematic diagram of an overall structure according to the present patent; and

FIG. 2 is a schematic diagram of a handle according to the present patent.

### DETAILED DESCRIPTION

In the description of the utility model, it should be noted that unless otherwise explicitly specified and defined, the terms "mount", "connect" and "connection" should be understood in a broad sense. For example, the connection may be fixed connection, detachable connection, or integral connection; or the connection may be mechanical connection or electrical connection; or the connection may be direct connection, indirect connection through an intermediary, or internal communication between two elements. A person of ordinary skill in the art may understand specific meanings of the foregoing terms in the utility model based on the specific situation.

The technical solutions in the embodiments of the utility model are described below clearly with reference to the accompanying drawings in the embodiments of the utility model. Apparently, the described embodiments are only some rather than all of the embodiments of the utility model. All other embodiments obtained by a person of ordinary skill in the art based on the embodiments of the utility model without inventive efforts fall within the scope of protection of the utility model.

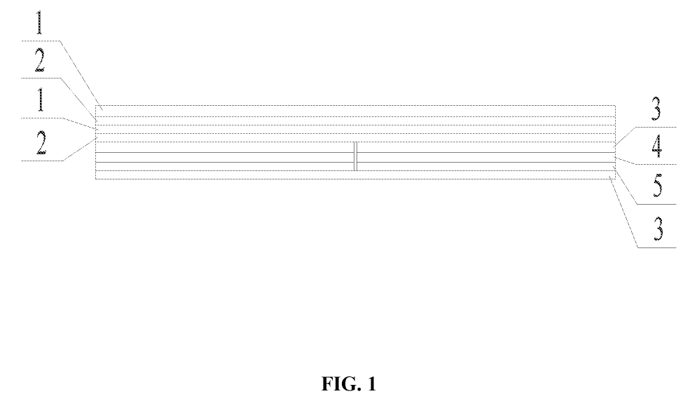

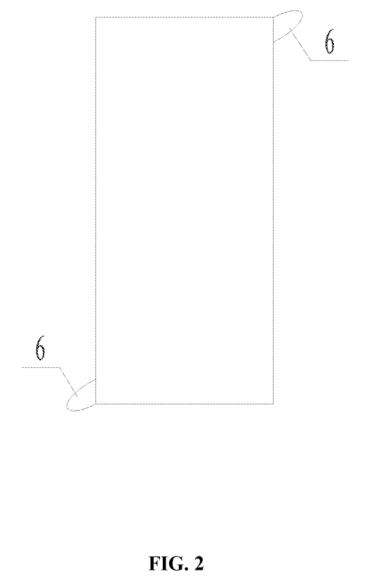

As shown in FIG. 1 and FIG. 2, the present application provides a segmented film, including a surface protective film and a bottom film which are arranged sequentially from top to bottom, where the surface protective film includes substrate for the surface protective films 1 and adhesive layers 2, the bottom film includes release layers 3 and a dust-sticking adhesive layer 5, and the bottom film is divided into several parts. According to the present application, a screen protective film is divided into a surface protective film and a bottom film, and then is layered; furthermore, the bottom film is not an integral structure. During film sticking, films can be stuck segmentally and then be uncovered segmentally.

The surface protective film has a double-layer structure, including an upper removing layer and a lower actual use layer; and each layer includes the substrate for the surface protective film 1 and the adhesive layer 2 which are combined together. The actual use layer is a layer of film body formed by performing anti-reflection (AR) treatment, anti-glare (AG) treatment, anti-blue-light treatment, anti-peep treatment, anti-fingerprint treatment and anti-scratch treatment or self-repairing treatment on a surface of a PET film, a PC film, a PMMA film or a TAC film.

The bottom film includes a release layer 3, a substrate layer 4, the dust-sticking adhesive layer 5 and the release layer 3 which are sequentially overlapped together from top to bottom. The release layer 3 may be made of silicon and non-silicon materials, so as to be the same as the adhesive layer 2 and the release layer 3 of the actual use layer, with a low release force and convenient film sticking. One embodiment of the present application is that the release layer 3, the substrate layer 4 and the dust-sticking adhesive layer 5 on the bottom film from top to bottom are of a split structure, and the release layer 3 at the bottom layer is of an integral structure, so that the release layer 3 at the bottom layer can be integrally torn off at one time, which is convenient and fast. The substrate layer 4 is a PET film, a PC film, a PMMA film or a TAC film. The bottom film is divided into left and right sections in a midline. During use, the release layer 3 below the left section may be uncovered to expose the dust-sticking adhesive layer 5 of this section to cover the screen for fixation and remove dust on the surface of the screen, then the release layer 3 of the right section is uncovered to make the dust-sticking adhesive layer 5 remove the dust on the surface of the screen, the dust-sticking adhesive layer 5 is uncovered and removed, and the substrate layer 4 is stuck and fixed on the screen. Then the removing layer of the surface protective film is uncovered, and the actual use layer is stuck and fixed on the substrate layer 4 of the bottom film through the adhesive layer 2 thereof. The bottom film provided by the present application can provide better alignment convenience for the actual use layer, thereby solving the problem of poor alignment when a common protective film is stuck on the screen after the release film is torn off and the problem that dust and bubbles are mixed when the film is torn off again.

In the technical solution of the present application, alignment handles 6 as protruding portions are respectively arranged at two ends of the film. The alignment handles 6 are located on the removing layer of the surface protective film or on the bottom film, and the alignment handles 6 are arranged diagonally, which is convenient for users to adjust and align before film sticking.

In the utility model, the thickness of the release layer 3 and the dust-sticking adhesive layer 5 is greater than that of the single release layer 3, so that the stiffness of the whole protection can be effectively improved, and the alignment yield can be increased better, thereby avoiding the influence on the alignment yield by early contact with the screen due to the collapse of the middle of the film material during alignment.

It will be evident to those skilled in the art that the utility model is not limited to the details of the foregoing illustrative embodiments, and that the utility model may be embodied in other specific forms without departing from the spirit or essential features of the utility model. Therefore, the embodiments should be regarded as exemplary and non-limiting in every respect, and the scope of the utility model is defined by the appended claims rather than the above description. Therefore, all changes falling within the meaning and scope of equivalent elements of the claims should be included in the utility model. Any reference numeral in the claims should not be considered as limiting the involved claims.

It should be understood that although this specification is described in accordance with the embodiments, not every embodiment includes only one independent technical solution. Such a description is merely for the sake of clarity, and those skilled in the art should take the specification as a whole. The technical solutions in the embodiments can also be appropriately combined to form other embodiments which are comprehensible for those skilled in the art.

### DESCRIPTION OF REFERENCE NUMERALS

1: substrate for the surface protective film

2: adhesive layer

3: release layer

4: substrate layer

5: dust-sticking adhesive layer

6: alignment handles

What is claimed is:

1. A segmented film, characterized in that, comprising a surface protective film and a bottom film which are sequentially arranged from top to bottom, wherein the surface protective film comprises substrate for the surface protective films and adhesive layers, the bottom film comprises release layers and a dust-sticking adhesive layer, and the bottom film is divided into several parts.

2. The segmented film according to claim 1, characterized in that: the surface protective film has a double-layer structure, comprising an upper removing layer and a lower actual use layer; and each layer comprises the substrate for the surface protective film and the adhesive layer which are combined together.

3. The segmented film according to claim 2, wherein the actual use layer is a layer of film body formed by performing anti-reflection (AR) treatment, anti-glare (AG) treatment, anti-blue-light treatment, anti-peep treatment, anti-fingerprint treatment and anti-scratch treatment or self-repairing treatment on a surface of a PET film, a PC film, a PMMA film or a TAC film.

4. The segmented film according to claim 1, characterized in that: the bottom film comprises a release layer, a substrate layer, the dust-sticking adhesive layer and the release layer which are sequentially overlapped together from top to bottom.

5. The segmented film according to claim 4, characterized in that: the release layer, the substrate layer and the dust-sticking adhesive layer on the bottom film from top to bottom are of a split structure, and the release layer at the bottom layer is of an integral structure.

6. The segmented film according to claim 4, characterized in that: the substrate layer is a PET film, a PC film, a PMMA film or a TAC film.

7. The segmented film according to claim 1, characterized in that: the bottom film is divided into left and right sections in a midline.

8. The segmented film according to claim 1, characterized in that: alignment handles as protruding portions are respectively arranged at two ends of the film.

9. The segmented film according to claim 8, wherein the alignment handles are located on a removing layer of the surface protective film or on the bottom film, and the alignment handles are arranged diagonally.
